(19) United States
(12) Patent Application Publication
(10) Pub. No.: US 2003/0083971 A1
(43) Pub. Date: May 1, 2003

(54) Method and system for determining optimal portfolio

(76) Inventors: Shigeru Kawamoto, Hitachi (JP); Yasuhiro Kobayashi, Hitachinaka (JP); Masanori Takamoto, Hitachi (JP); Osamu Kubo, Hitachi (JP); Takeshi Yokota, Hitachi (JP); Yuuji Ide, Yokohama (JP)

Correspondence Address: DICKSTEIN SHAPIRO MORIN & OSHINSKY LLP, 2101 L STREET NW, WASHINGTON, DC, 20037-1526, US

(21) Appl. No.: 10/091,033

(22) Filed: Mar. 6, 2002

(30) Foreign Application Priority Data
Oct. 29, 2001 (JP) 2001-330506

(51) Int. Cl. G06F 17/60

(52) U.S. Cl. 705/36

(57) ABSTRACT

An optimal portfolio determining method enables high speed determination of objective financial product which optimize availability for institutional buyer or retail investor and purchasing amount on the basis of information relating to earning rate or the like of individual name and information relating to information factors influencing for earning rate, and a system for realizing the method. The method includes input step of inputting constraint parameters forming constraint condition for optimizing objective function consisted of an expected value of the earning rate of each individual financial product, individual floating factor as unique factor of each individual financial product influencing for earning, common floating factor as factor influencing for earning of overall financial products, and risk influencing for earning rate and earning of overall financial product, and solving step of determining financial product to perchance and purchasing amount for maximizing the objective function on the basis of input data.

### BACKGROUND OF THE INVENTION

The present invention relates to a method and system for determining an optimal portfolio for determining financial product to be object for purchasing among a plurality of financial products, a program therefor and a storage medium storing the program.

As a model to be employed upon determining optical portfolio, in a group of financial products to take as object for purchasing (hereinafter, object for purchasing is exemplarily assumed as universe consisted of group of stocks (two hundreds twenty-five names as whole of the First Section of Tokyo Stock Exchange), under a premise of fixing an earning rate at a predetermined value, a mean dispersion model employing a quadratic programming for minimizing secondary objective function expressed as a risk indicative of fluctuation of the earning rate, or multi-factor model are introduced in Hiroshi Konno “Chrematistics Technology I”, Nikka Giren, pp 4 to 19.

On the other hand, Japanese Patent Application Laid-Open No. 2000-293569 discloses a model according to a linear programming for maximizing a sum of expected earning rate consisted of a plurality of scenario and a period as an optimal portfolio determination method, under (1) a constraining condition by a function taking market price as parameter and (2) a constraining condition for performing control relating to possible gain and loss.

As a mathematical programming, such as quadratic programming or linear programming, an effective constraint method and so on are typically known as introduced in Toshihide Ibaragi and Masao Fukushima “FORTRAN 77 Optimization Programming” Iwanami Shoten, pp 87 to 113, and so forth, for example. In the mathematical programming, it is a typical method to repeat updating a point string from an initial point to a point where an optical solution is obtained. Upon updating the point string, a most part of process is matrix operation for deriving a direction for retrieving the point string. In the matrix appearing upon formulation into quadratic programming problem, most of factors are zero. For processing such matrix, it has been known a sparse method for implementing matrix operation with discriminating factor of zero on the program.

The sparse method is an general purpose approach as a method for matrix operation process in the quadratic programming. However, in viewpoint of application for a problem of determination of optimal portfolio, in case of a problem having several thousands of parameters, huge calculation period is required even in the sparse method for necessity of discrimination of the factors of zero on the program. While the recent computers are significantly advanced, upon practically determining portfolio, shortening of calculation period of the quadratic programming is strongly demanded for necessity of solving the quadratic programming for number of times with updating objective function or constraint function.

On the other hand, in the system disclosed in Japanese Patent Application Laid-Open No. 2000-293569, since no detail of mathematical programming has been disclosed, upon application of the mathematical programming, a system employing the sparse method is employed to encounter the similar program.

### SUMMARY OF THE INVENTION

An object of the present invention to provide an optimal portfolio determining method enabling high speed determination of objective financial product which optimize availability for institutional buyer or retail investor and purchasing amount on the basis of information relating to earning rate or the like of individual name and information relating to information factors influencing for earning rate, and a system for realizing the method.

Another object of the present invention is to provide a program indicative of process procedure of the optimal portfolio determining method and a storage medium storing the program.

In order to accomplish the above-mentioned and other objects, according to the first aspect of the present invention, an optimal portfolio determining method for determining purchasing amounts of respective financial products among a plurality of financial products so as to optimize an objective function consisted of earning rate of all of a plurality of financial products and risk influencing for earning, comprises:

input step of inputting constraint parameters forming constraint condition for optimizing objective function consisted of an expected value of the earning rate of each individual financial product, individual floating factor as unique factor of each individual financial product influencing for earning, common floating factor as factor influencing for earning of overall financial products, and risk influencing for earning rate and earning of overall financial product; and

solving step of determining financial product to perchance and purchasing amount for maximizing the objective function on the basis of input data.

In the preferred construction, the optimal portfolio determining method may further comprise preliminary process step of processing of dividing a coefficient matrix appearing in the objective function into a partial matrix relating to individual floating factor of each individual financial product, and a partial matrix relating to the common floating factor, upon determining the financial product to purchase and purchasing amount.

In the alternative, the optimal portfolio determining method may further comprise preliminary process step of processing of dividing a matrix consisted of the constraint parameters into a partial matrix relating to the financial products and the common floating factor, a partial matrix relating to the common floating factor, and a partial matrix relating to the financial product and purchasing amount thereof.

In the further alternative, the optimal portfolio determining method may further comprise preliminary process step of processing of dividing a matrix consisted of the constraint parameters into a partial matrix relating to the financial products and the common floating factor, a partial matrix relating to the common floating factor, a partial matrix relating to the financial product and purchasing amount thereof, and a partial matrix relating to purchasing amount of each group in the case where the financial products are grouped into a plurality of groups.

In such case, the partial matrix relating to the individual floating factor may be a diagonal matrix having elements in a portion of diagonal component corresponding to number of financial products to be selected. The partial matrix relating to the common floating factor may be a matrix taking square of the common floating factor as dimension. The partial matrix relating to the common floating factor may also be a diagonal matrix having element in a portion of diagonal component corresponding to number of the common floating factor. The partial matrix relating to constraint for purchasing amount of the financial product may be a diagonal matrix having element in a portion of diagonal component corresponding to number of the common floating factor. The partial matrix relating to the financial product and the common floating factor may be a matrix taking a product of the financial product and the common floating factor as dimension. The partial matrix relating to constraint for purchasing amount of the group, in which the financial products belong, may be a matrix taking a product of number of the groups and the financial products.

In the further preferred construction, the optimal portfolio determining method may further comprise display step outputting the risk indicative of variation of earning and earning rate consisting the objective function.

According to the second aspect of the present invention, an optimal portfolio determining system having a computer unit for determining purchasing amounts of respective financial products among a plurality of financial products so as to optimize an objective function consisted of earning rate of all of a plurality of financial products and risk influencing for earning, the computer unit comprises:

storage device storing an expected value of the earning rate of each individual financial product;

storage device storing individual floating factor as unique factor of each individual financial product influencing for earning,

storage device storing common floating factor as factor influencing for earning of overall financial products, and

storage device storing constraint parameters forming constraint condition for optimizing objective function consisted of risk influencing for earning rate and earning of overall financial product;

optimal portfolio solving device determining financial product to perchance and purchasing amount for maximizing the objective function on the basis of data stored in the storage device; and

display device outputting determined optimal portfolio.

The computer unit may comprise a server computer including respective storage devices and the optimal portfolio deriving device, and a plurality of client computers receiving information relating to the optimal portfolio calculated by the server computer for displaying, and the sever computer and the client computers are connected through a network.

According to the third aspect of the present invention, a optimal portfolio determining program being readable by a computer includes input step and solving step of the optimal portfolio determining method set forth above.

According to the fourth aspect of the present invention, a storage medium storing a program readable by a computer which stores a program executing input step and solving step of the optimal portfolio determining method set forth above.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing a construction of the preferred embodiment of an optimal portfolio determining system according to the present invention;

FIG. 2 is an explanatory illustration of a first data type to be input to an individual earning rate database;

FIG. 3 is an explanatory illustration of a second data type to be input to an individual factor database;

FIG. 4 is an explanatory illustration of a data type to be input to a common factor database;

FIG. 5 is an explanatory illustration of a data type to be input to a constraining parameter database;

FIG. 6 is an explanatory illustration showing another example of data type of constraining parameter;

FIG. 7 is an explanatory illustration showing one example of type of objective function of formulated quadratic programming;

FIG. 8 is an explanatory illustration showing one example of type of constraining expression of formulated quadratic programming;

FIG. 9 is an explanatory illustration showing one example of type of objective function of quadratic programming problem after formulation and conversion into a predetermined type;

FIG. 10 is an explanatory illustration showing one example of constraining expression of quadratic programming problem after formulation and conversion into a predetermined type;

FIG. 11 is a flowchart showing general process of solution of the objective quadratic programming problem;

FIG. 12 is a flowchart showing a detailed process of solution of the objective quadratic programming problem;

FIG. 13 is a first explanatory illustration showing a calculation method of violation amount of constraining condition;

FIG. 14 is a second explanatory illustration showing a calculation method of violation amount of constraining condition;

FIG. 15 is a first explanatory illustration showing a method for deriving a solution of Newton's equation;

FIG. 16 is a second explanatory illustration showing a method for deriving a solution of Newton's equation;

FIG. 17 is a third explanatory illustration showing a method for deriving a solution of Newton's equation;

FIG. 18 is a fourth explanatory illustration showing a method for deriving a solution of Newton's equation;

FIG. 19 is a first explanatory illustration showing an output type of optimal portfolio;

FIG. 20 is a second explanatory illustration showing an output type of optimal portfolio;

FIG. 21 is a third explanatory illustration showing an output type of optimal portfolio; and

FIG. 22 is an illustration showing a construction of one example of an optimal portfolio determining system.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

The present invention will be discussed in detail in terms of a system for determining an optimal portfolio for determining an objective financial product for purchasing among a plurality of financial products and purchasing amount so as to maximize gain and to minimize risk indicative of element to fluctuate the gain by a mathematical programming, such as linear programming or non-linear programming. With the system, institutional buyer and general investor may determine the optimal portfolio using computer. The preferred embodiment of the present invention will be discussed with reference to the accompanying drawings. At first, discussion will be given for algorithm of optimal portfolio determination.

In a problem of portfolio selection taking a plurality of stocks (here, all stocks in the First Section of Tokyo Stock Exchange) as a group of financial products to be objects for purchasing, an objective function is a utility function as expressed by the following expression (1) established by a sum of an earning rate expressed by a sum of products of multiplication of expected earning rate of each stock and investing rate, and a value calculated by multiplying a measure of risk aversion and an active risk expressed by a deviation rate between bench mark ratio indicative of a rate of current value of each individual name versus total current value of overall stocks and investing rate of each individual name:

U=á^{T}hₚ−ë(hₚ−hₘ)^{T}G(hₚ−hₘ) (1)

wherein á is a vector taking expected earning rate of individual name as element, ë is measure of risk aversion held by the investor (ë is set greater as giving preference for risk aversion and is set smaller as giving preference for increase of gain of entire portfolio), hₚ is a vector taking investment ratio of each name as element, hₘ is a vector taking a bench mark ratio as element, and G is a matrix taking covariance between gain rates of individual names.

Discussion with be given hereinafter for an example in terms of the case where the following expressions are taken as constraint expression in the utility function as expressed by the foregoing equation (1). In the following expression, e represents a vector in which all elements are 1.

e^{T}hₚ=1 (overall investment ratio is 1) (2)

hₚ 0 (constraint for inhibiting short selling)

Setting method of such utility function has been disclosed in R. C. Grinold and R. N. Kern “Active Portfolio Management” Toyo Keizai Shinbunsha, pp 81 to 87. The disclosure in this publication is herein incorporated by reference.

In a mean dispersion model, the quadratic programming is applied with taking the utility function expressed by the foregoing equation (1) as objective function. However, in the mean dispersion model, when a thousand five hundreds of names in the First Section of Tokyo Stock Exchange are taken as objective for calculation, 2250000 of values of covariance between earning rates of individual names are inherently included in the objective function. Upon solving the problem of the quadratic programming having such objective function, it is expected to take a huge amount of time. Therefore, such approach is not practical for the problem of portfolio selection with mean dispersion model.

A model to be employed for solving the shortcoming of the mean dispersion model is multi-factor model. In the multi-factor model, the earning rate of each individual name is expressed as the following equation (4) with common factor influencing for earning rate of overall names and individual factor variable depending upon factors unique to each individual name.

áⱼ=ã_{d}+ÓâⱼₖFₖ+åⱼ (4)

wherein âⱼₖ is a parameter representative of influence for the earning ratio of individual name j when a factor Fₖ of the common factor k is varied by one unit, and is referred to as factor exposure. For example, when the common factor is yen-dollar exchange rate, and if $1=¥123, 123 is assigned as Fₖ. On the other hand, if the earning rate is varied 0.1% when the exchange rate is varied from $1=¥123 to $1=¥124, 0.1 is assigned as âⱼₖ.

While detail has been eliminated herefrom so as to maintain disclosure simple enough to facilitate clear understanding of the present invention as disclosed in Hiroshi Konno, “Chrematistics I”, Nikka Giren, pp 18 to 19. The above-identified passage of the publication will be herein incorporated by reference, using a matrix B consisted of âⱼₖ, a matrix F consisted of dispersion and covariance of Fₖ, and a diagonal matrix Ä having a specific risk expressed by dispersion of åⱼ as diagonal component, the covariance matrix G of the earning rate of each individual name is expressed by the following equation (5):

G=B^{T}FB+Ä (5)

Substituting the foregoing equation (1) with the equation (5), and assuming Bhₚ=y, the following equation (6) is established:

$$\begin{matrix}U = {á}^{T} {h}_{p} - {ë ( {h}_{p} - {h}_{m} )}^{T} G ( {h}_{p} - {h}_{m} ) \\ = {á}^{T} {h}_{p} - ë {h}_{p}^{T} {Gh}_{p} + 2 ë {h}_{p}^{T} {Gh}_{m} - ë {h}_{m}^{T} {Gh}_{m} \\ = - ë {h}_{p}^{T} {Gh}_{p} + ( {á}^{T} + 2 ë {h}_{m}^{T} G ) {h}_{p} - ë {h}_{m}^{T} {Gh}_{m} \\ = - ë {h}_{p}^{T} ( {B}^{T} FB + Ä ) {h}_{p} + ( {á}^{T} + 2 ë {h}_{m}^{T} G ) {h}_{p} - ë {h}_{m}^{T} {Gh}_{m} \\ = - ë {y}^{T} Fy - ë {h}_{p}^{T} Ä {h}_{p} + ( {á}^{T} + 2 ë {h}_{m}^{T} G ) {h}_{p} - ë {h}_{m}^{T} {Gh}_{m}\end{matrix} \qquad ( 6 )$$

In the multi-factor model, the utility function derived from the foregoing equation (6) is taken as object of the objective function to be maximized. Furthermore, in the multi-factor model, by assuming Bhₚ=y, new parameter y is generated. In conjunction therewith, not only the constraint expressions (2) and (3) but also the following constraint expression (7) have to be considered.

Bhₚ−y=0

It should be noted that the present invention can be embodied even in the case where the covariance matrix G is in a form other than that shown by the equation (5). Hereinafter, mode of implementation of the invention in connection with determination of optimal portfolio in multi-factor model will be discussed.

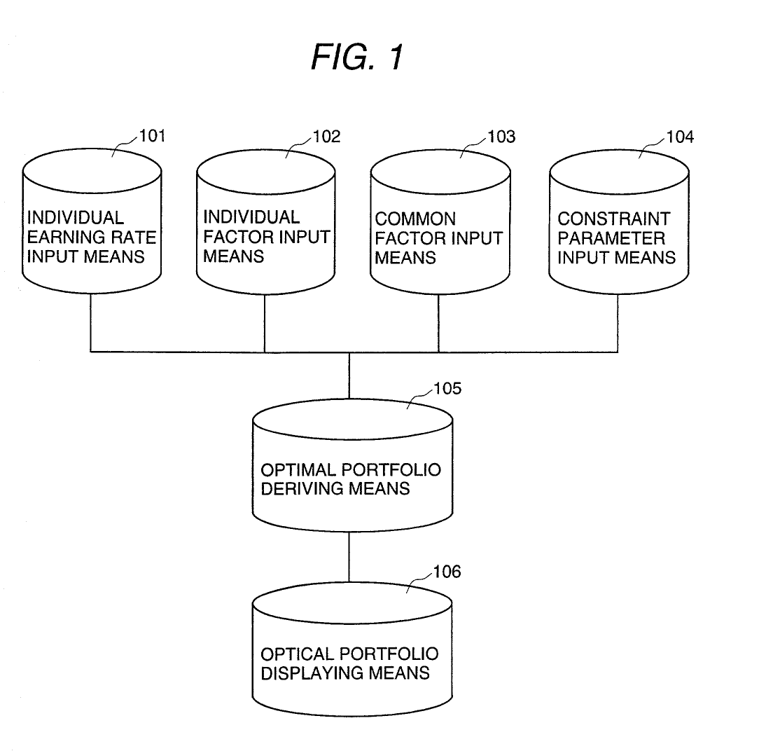

FIG. 1 shows a general construction of the optimal portfolio determination system according to the present invention. The optimal portfolio determination system is constructed with individual earning rate input means (database) 101, individual factor input means (database) 102, common factor input means (database) 103, constraining parameter input means (database) 104, optimal portfolio derivingmeans 105 and optimal portfolio displaying means 106. Input means designated by 101 to 104 are formed as databases.

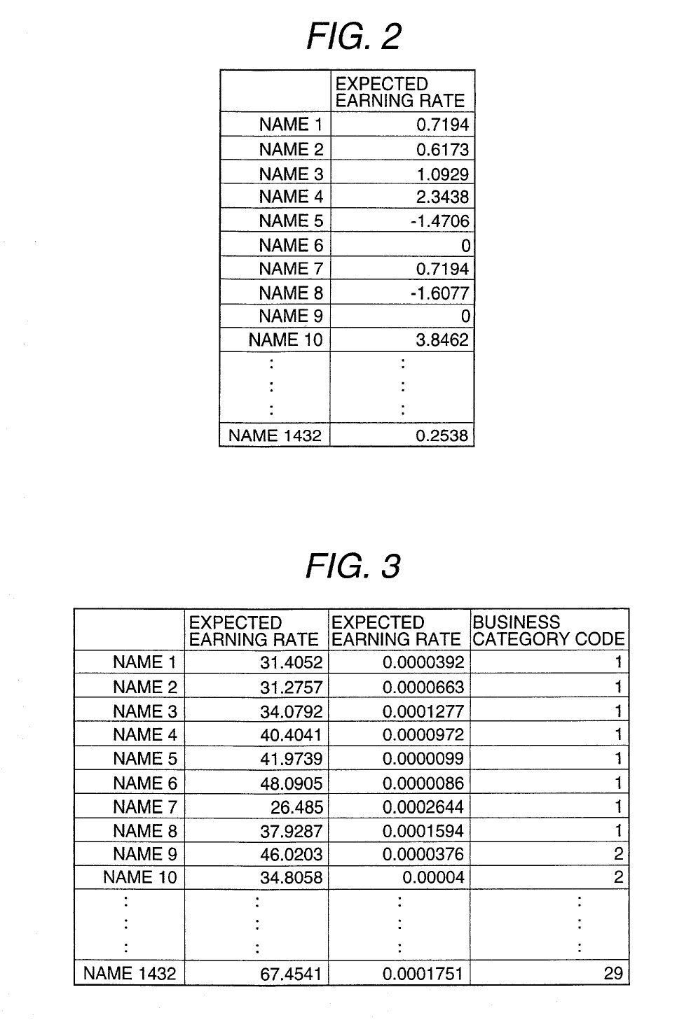

In the individual earning rate input means 101, information relating to an expected value of the earning rate of individual name is input. One example of data shown in FIG. 2 is directed to 1432 individual names. Information relating to an expected value of the earning rate as a result of prediction whether the current stock prices is in comparatively low in price or not on the basis of past record, is input.

In the individual factor input means 102, information relating to the specific risk, in which fluctuation factor of earning rate of the individual name is discussed as factors unique for the individual name, bench mark ratio indicative of a rate of current value of each individual name versus total current value of overall stocks, are input. One example of data shown in FIG. 3 are directed to 1432 of individual names, in which business category code (electric equipment manufacturer, transporting equipment manufacturer, banking service and so forth, in which each individual name belongs, is input in addition to the specific risk, bench mark ratio and so forth.

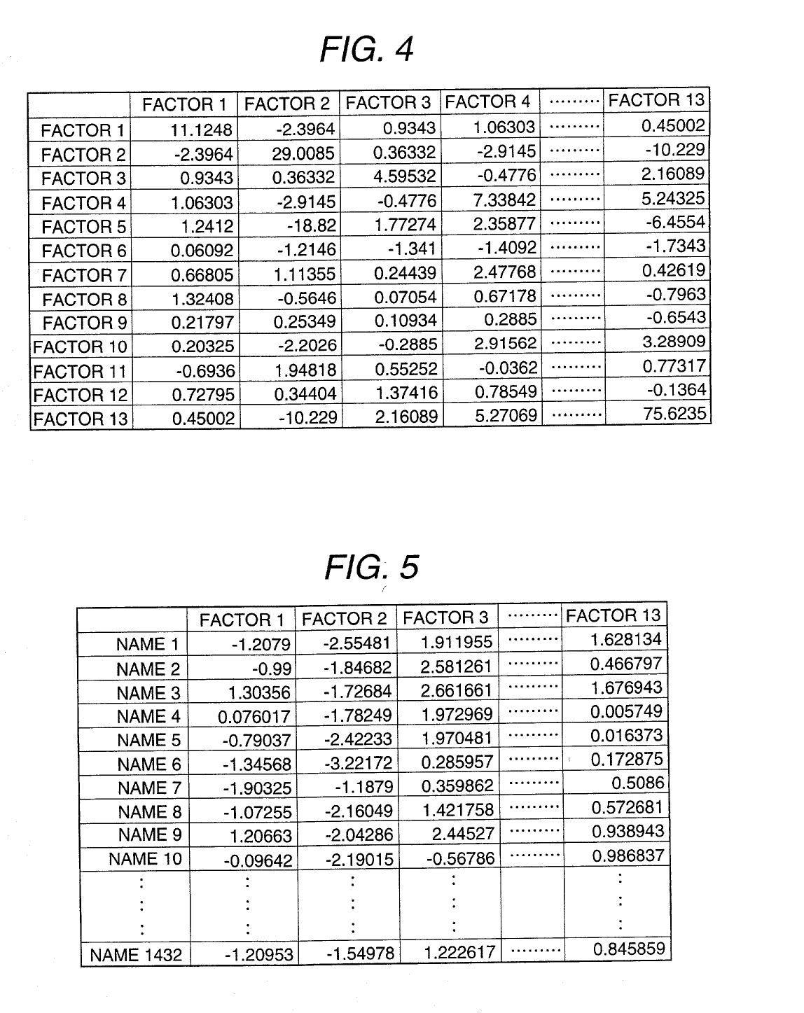

The common factor input means 103 inputs information relating to covariance between two common factors in among factors common to influence for earning rate of overall names (hereinafter referred to as common factor). One example of data shown in FIG. 4 concerns 13 common factors and indicates inputting of 13×13 data. While covariance of factor 1 and factor 2 is negative, this indicates that when a matter to make the factor 1 greater, is caused, the value of the factor 2 can become smaller with high probability. Conversely, when the covariance of factor 1 and factor 3 is positive, this indicates that when a matter to make the factor 1 greater, is caused, the value of the factor 3 can become greater with high probability.

The constraining parameter input means 104 inputs data relating to factor exposure representative that when the common factor influencing to earning rate of overall names as discussed in FIG. 4 and data relating to investment ratio constraint to business category group (in which a plurality of business categories are grouped) belonging each name.

On example of data shown in FIG. 5 relates to 13 common factors and 1432 names. Focusing particular factor, for example, when the value of the factor 1 becomes greater, in the names where the value of the factor exposure becomes negative as names 1 to 3, 5 to 8, 10 . . . 1432, it serves in a direction to reduce the earning rate. Conversely, in the names where the value of the factor exposure becomes positive as names 4, 9 . . . , it serves in a direction to increase the earning rate.

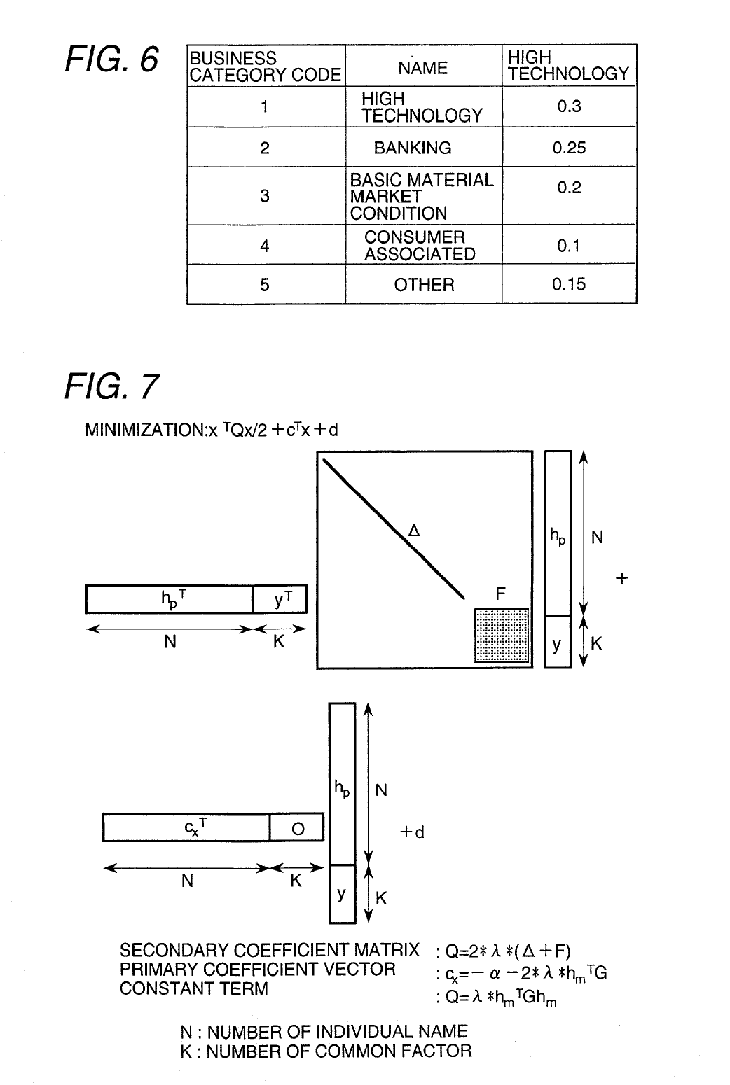

One example of data shown in FIG. 6 shows constraint relating to investment ratio for respective business category groups when each individual names are classified into five business category groups. It indicates that the investment ratio to the name belonging the business category group 3, for example, is set to 2 (=20%). This data is input to the constraining parameter input means 104 only when consideration is given for the constraint of investment ratio for each business category group. It should be noted that the constraint of investment ratio can be input by inequality, such as greater than or equal to 0.15 and less than or equal to 0.25.

In the optimal portfolio deriving means 105, objective stock to purchase and purchasing ratio are determined on the basis of information input from input means 101 to 104. In the optimal portfolio deriving means 105, measure is taken for method to determine assignment of the optimal portfolio. The measure will be discussed later.

The optimal portfolio display means 106 outputs useful information for investor or fund manager active in fund operation for capital fund deposited by customer.

The optimal portfolio deriving means is constituted of step of generating optimization problem on the basis of information input through respective databases (input means) 101 to 104, and step of solving the optimization problem. As a solution for the optimization problem, mode of implementation according to an interior solution, in which number of times of updating of point string becomes small even for large scale problem and demonstrate superior performance, will be discussed. Mode of implementation of the invention may also employ simplex method in linear programming problem or active set method in quadratic programming problem.

The optimization problem is normally formulated into standard type of quadratic programming problem as expressed by the following expressions (8) and (9).

Minimization: c^{T}x+x^{T}Qx/2+d (8)

Constraining Expression: Ax=bx≧0 (9)

wherein c is N-dimension vector, Q is N-dimension quadratic matrix, A is M×N matrix, b is M-dimension vector.

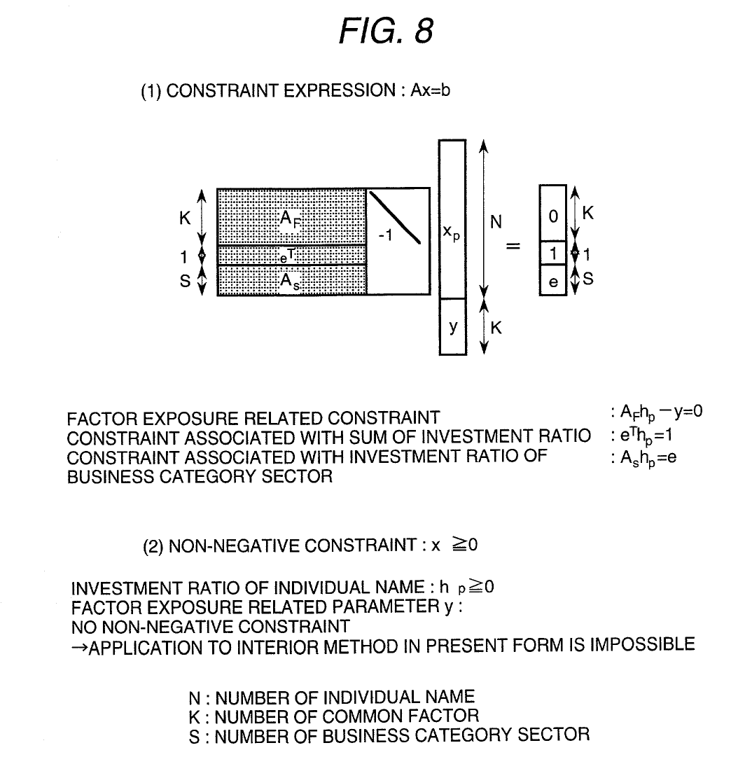

FIGS. 7 and 8 show structure of the portions containing elements in constraining expression of the objective function of the foregoing expression (8) and the expression (9).

In the objective function of FIG. 7, in a matrix Q indicative of secondary coefficient of the objective function, non-zero elements are contained only in diagonal part matrix A at left upper portion and a partial matrix F of right lower portion. All elements in remaining part are zero. Namely, when number of names and number of common factors are 1432 and 13, respectively, among about 2,080,000 of overall elements containing 0, elements containing other than 0 are 1600 which is less than 0.1% of overall elements. By considering of nature of secondary coefficient matrix, speeding up of optimizing operation becomes possible. It should be noted that, in a vector c indicative of primary coefficient of the objective function, most of elements are other than 0. However, comparing with the secondary coefficient matrix, no significant problem will be arisen for much lesser number of elements.

In the constraint expression of FIG. 8, in the matrix A appearing on left section of the constraint expression, elements other than 0 are contained only in the left half and the diagonal part in right upper portion. Upon speeding up the optimizing operation, it is required to consider such nature.

Next, upon focusing parameters hₚ and y appearing in the objective function of the optimization problem shown in FIG. 7, in order to apply the interior solution as the quadratic programming, both parameters has to be positive. However, the parameter y introduced for handling the common factor does not satisfy non-negative constraint appearing in the constraint expression (9) of the quadratic programming problem as shown in FIG. 8. Therefore, the interior solution as one of typical solutions for the quadratic programming problem shown in FIGS. 7 and 8 cannot be applied as is. In order to make the interior method applicable, it becomes necessary to convert the parameters by adding sufficiently large positive number s as shown in the expression (10) so that the parameter becomes positive. In the expression (10), the vector e in the expression (10) represents the vector, in which all elements are 1.

Y=y+s*e (10)

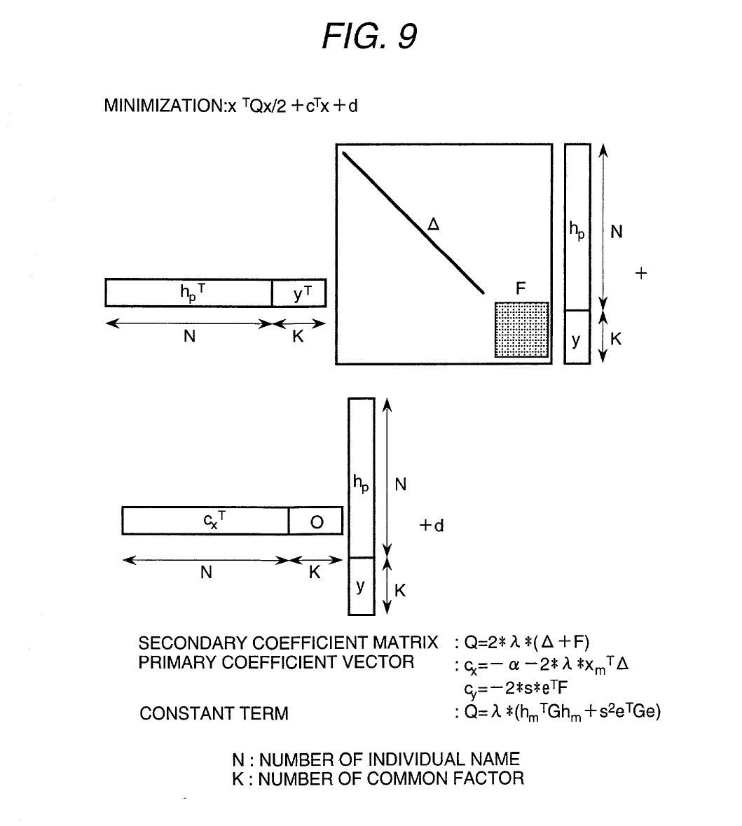

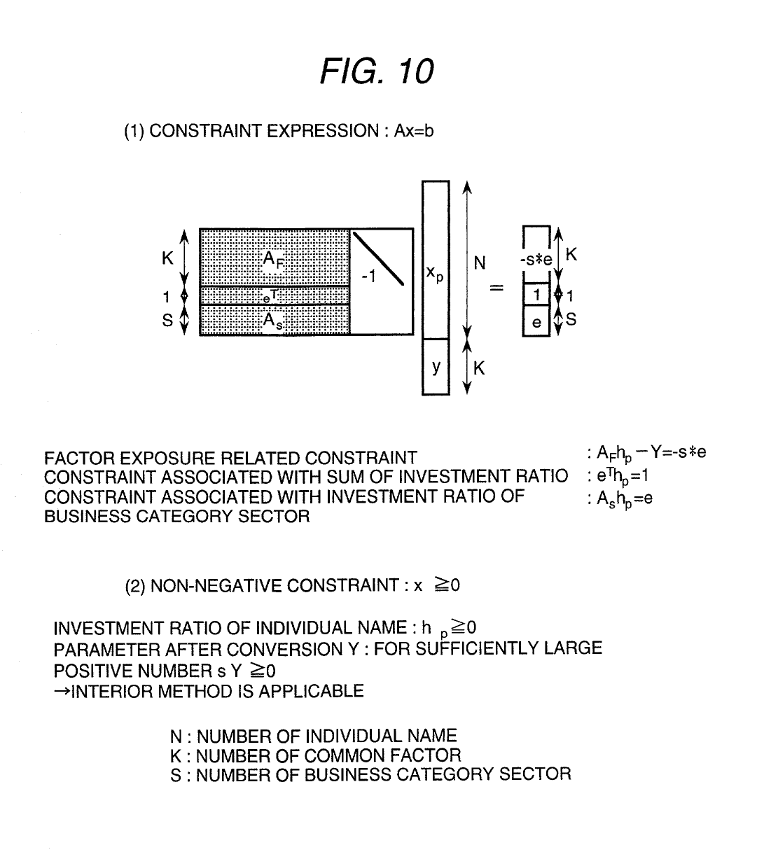

After such conversion, namely after modification by substituting with y=Y−s*e, the structure of the quadratic programming problem becomes as shown in FIGS. 9 and 10. Difference between FIGS. 9, 10 and FIGS. 7, 8 are different in such a manner that the right section of the primary coefficient vector is modified from elements of 0 to elements other than 0 (see FIGS. 7 and 9), and upper side of the right side vector of the constraining expression is modified from elements of 0 to elements other than 0 (see FIGS. 8 and 10). However, since no particular difference is present concerning basic structure of the matrix, calculation amount will not be influenced.

Next, discussion will be given for optimal portfolio deriving means. At first, the interior solution as solution of the optimization problem will be briefly discussed with reference to the drawings.

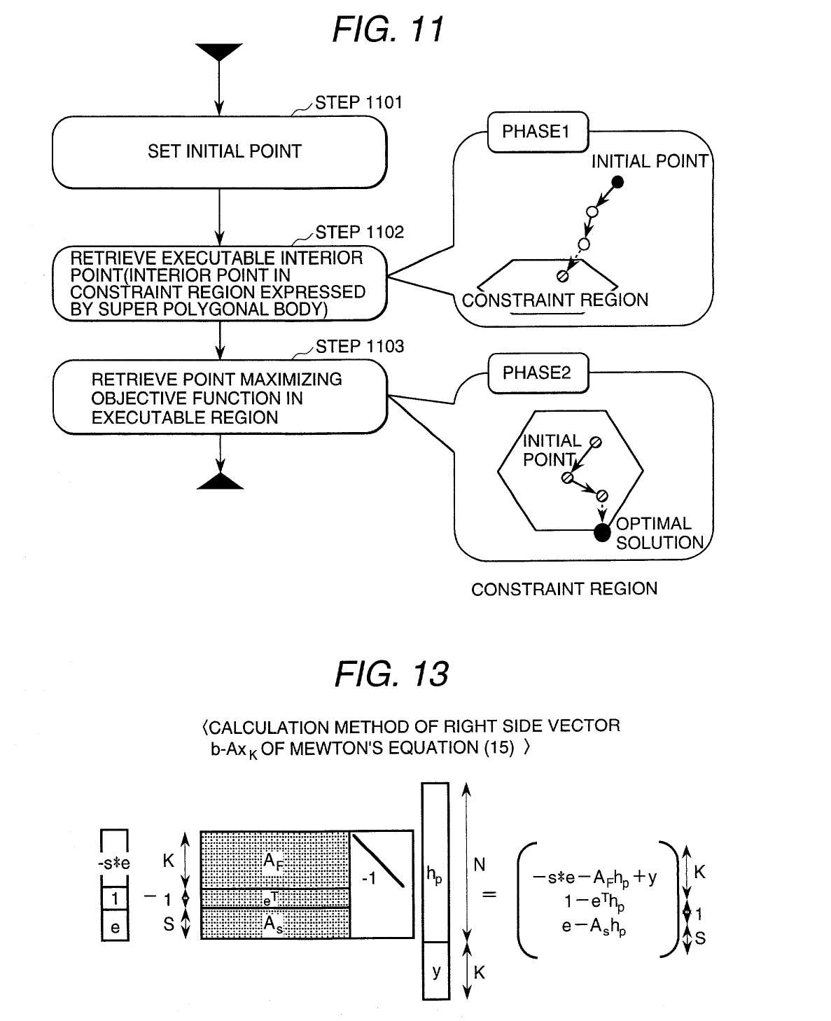

FIG. 11 is a conceptual illustration of overall process of the interior solution. At first, at step 1101, an initial point is set. Next, at step 1102, retrieving direction is derived by Newton's method so that violation amount of the constraint condition is made as small as possible for updating the point string. By this step 1102, points within the constrained region are retrieved. Finally, at step 1103, retrieval is performed for a point within an constrained region where the objective function can be maximized.

Basically, the retrieving direction is derived by the Newton's method to make a different of objective functions of the primal problem (original problem) and dual problem (quadratic programming problem derived from the primal problem) as small as possible, for updating point string. By repeating point string as set forth above, when the difference of the objective functions becomes 0, the optimal solution can be obtained.

On the other hand, in the interior solution, when the optimal solution of the quadratic programming problem is assumed as x* and appropriately selecting y* and z* corresponding to equation constraint and inequality constraint (non-negative constraint of x), (x, y, z)=(x*, y*, z*) satisfies the following non-linear equation. The theoretical background has been disclosed in Hidetoshi Ibaragi and Masao Fukushima “FPRTRAN 77 Optimal Programming” Iwanami Shoten, pp 453 to 457. The disclosure of the above-identified publication is herein incorporated by reference, and detailed discuss ion is eliminated for keeping the disclosure simple enough to facilitate clear understanding of the present invention. The constraining condition of the primal problem is expressed by the following expression (11), the constraining condition of the dual problem is expressed by the following equation (12), and complementary condition is expressed by the following expression (13).

Ax=b (11)

A^{T}y−Qx+z=c (12)

x^{T}z=0, x≧0, z≧0 (13)

The solution of the quadratic programming problem may be attained by solving the foregoing non-linear equation. In the interior solution, modifying the non-linear equation by using positive real number and modifying the complementary condition as the following expression (14):

x^{T}z=ì, x>0, z>0 (14)

Particularly, ì is set at positive number which is great in some extent, approximately solving the non-linear equation, the point string (x_{K}, y_{K}, x_{K}) (K=0, 1, 2, 3, 4 . . . ) is updated sequentially with making smaller value to 0, the optimals olution for the quadratic programming problem can be derived.

In actual programming operation, ì is set in â*x_{K}^{T}z_{K}/n so that retrieving direction is controlled in such a manner that the retrieving direction is shifted to be closer to the value 1 when the solution is out of the constraining region, and to be closer to the value 0 when the solution falls within the constraining region, and the Newton's equation shown by the following expressions (15) to (17) is solved.

Adx=−(AXₖ−b) (15)

A^{T}dy−Qdx+dz=−(A^{T}yₖ−Qxₖ+zₖ−c) (16)

$$\begin{matrix}{Z}_{k} dx + {Z}_{k} dz = - ( {X}_{k} {z}_{k} - ì * e ) \\ = - \{ {X}_{k} {z}_{k} - ( â * {x}_{k}^{T} {z}_{k} / n ) * e \}\end{matrix} \qquad ( 17 )$$

Deriving the retrieving direction by solving the Newton's equation, and reducing the violation amount of the constraining condition and complementary condition set forth above, a step width satisfying x>0 and z>0 is calculated for updating the point string. It should be noted that in the foregoing expression (17), Xₖ and Zₖ are diagonal matrix taking the vector at respective repetition point as diagonal element, and e is vector where all elements are 1.

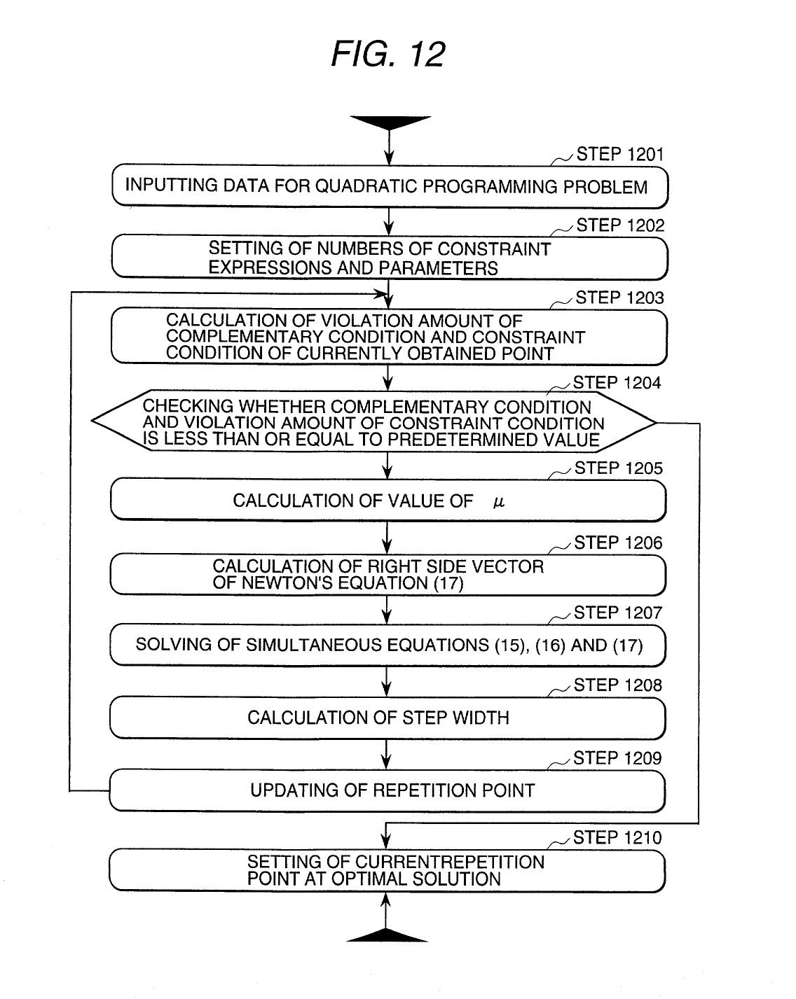

Algorithm of the quadratic programming designed in consideration of the foregoing matters is constituted with steps 1201 to 1210 as shown in FIG. 12. The process at step 1201 corresponds to inputting data of the quadratic programming problem from the individual earning rate database, the individual factor database, the common factor database and the constraint parameter database. The process at steps 1202 to 1210 correspond to process for deriving solution of the optimal portfolio in the optimal portfolio deriving means. Processes at steps 1201 to 1210 will be discussed hereinafter in detail.

<Step 1201: Inputting Data for Quadratic Programming Problem>

At step 1201, data for quadratic programming problem are input. Data to be input here are data relating to an expected value of the earning rate of each of the individual names shown in FIG. 2, data relating to attribute of each of the individual names shown in FIG. 3, data relating to dispersion of common factor and covariance influencing for earning of overall names shown in FIG. 4, and data relating to factor exposure representative of degree of influence of each common factor forearningofeachindividualfactorshowninFIG. 5. Itshould be noted that when the constraint for investment ratio is to be taken into account, data to be input may include data relating to the constraint for investment ratio for the business category group shown in FIG. 6 as data for the quadratic programming problem. However, if the constraint for investment ratio is not taken into account, data in FIG. 6 is not taken as data for quadratic programming problem.

<Step 1202: setting of Numbers of Constraint Expressions and Parameters>

At step 1202, number of constraint expressions and number of parameters in the quadratic programming problem are set. Assuming that the common factor input at step 1201, business category group to be considered as constraint (when not considered as constraint, 0 is set), and number of individual names as K, S and N respectively, numbers of the constraint expression and parameters are respectively expressed by (K+1+S) and (K+N).

<Step 1203: Calculation of Violation Amount of Complementary Condition and Constraint Condition of Currently Obtained Point>

At step 1203, Newton's equations (15) and (16) and a normed value of right side vector of right side vector indicating violation amount of the constraint condition and a value of xTz of left side of the constraint condition (13) are calculated.

The right side vector of Newton's equation (15) implements calculation by blocking as shown in FIG. 13. In calculation shown in FIG. 13, since it utilizing the fact that most element of right half of coefficient matrix are 0, it can be expressed as shown in right side in FIG. 13.

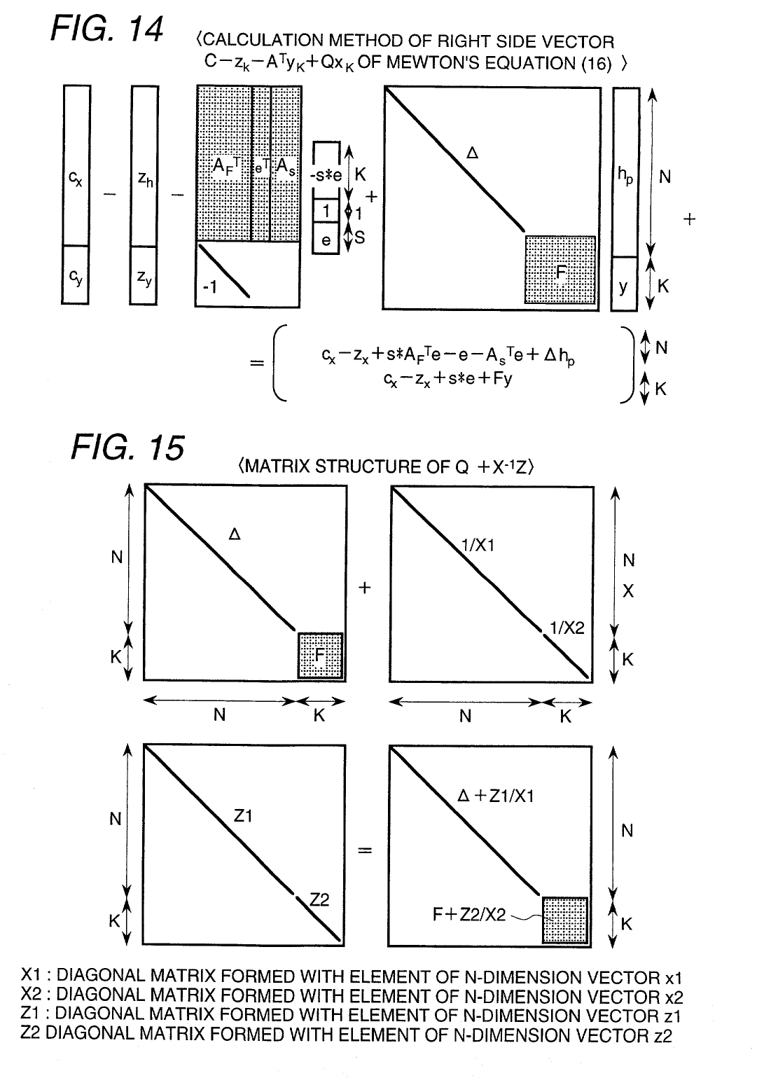

On the other hand, the right side vector of the Newton's equation (16) implements calculation by blocking as shown in FIG. 14. In calculation shown in FIG. 14, it utilizes the fact that the most element of the lower halt of the coefficient matrix A^{T} are 0 and elements other than 0 appear only in left upper diagonal portion and right lower portion of the coefficient matrix Q. As a result, it can be appreciated the right side of FIG. 14 can be established. It should be noted that FIGS. 13 and 14 show block diagrams of matrix for the case that investment ratio constraint of business category group is considered. If the investment ratio constraint of business category group is not considered, a portion relating to Aₛ becomes not present.

<Step 1204: Checking Whether Complementary Condition and Violation Amount of Constraint Condition is Less Than or Equal to Predetermined Value>

At step 1204, at currently obtained repetition point, judgment is made whether the violation amount of the constraint condition and the complementary condition fall within allowable error range or not. In practice, judgment is made whether the constraint conditions (11) and (12) and the complementary condition (13) are satisfied or not. In practical arithmetic operation on the computer, judgment is made whether the conditions (11), (12) and (13) are approximately satisfied or not. The complementary condition (13) is expressed as the following expression (13′).

∥x^{T}z|<å (13′)

An inequality having å sufficiently close to zero (e.g. 10⁻¹⁰ and so forth) is used for judgment of optimality.

<Step 1205: Calculation of Value of ì>

At step 1205, the value of ì relating to the Newton's equation (14) is calculated. In practice, (â*xₖ^{T}zₖ/n) shown in the foregoing equation (17) is set as the value of ì. It should be noted that the current repetition point does not satisfy the constraint condition (11), in order to retrieve the repetition condition satisfying the constraint condition (11), the value of a is set at a value close to one (e.g. 0.99). On the other hand, when the current repetition point satisfies the constraint condition (11), the value of a is set at a value close to 0 (e.g. 0.01) for retrieving the optimal solution. Such setting method of a respectively correspond to the processes at steps 1102 and 1103 as shown in FIG. 11.

<Step 1206: Calculation of Right Side Vector of Newton's Equation (17)>

At step 1206, calculation of the right side vector of Newton's equation (17) is performed.

<Step 1207: Solving of Simultaneous Equations (15), (16) and (17)>

At step 1207, the Newton's equations (15), (16) and (17) are solved to derive a retrieving direction (dx, dy, dz) of the current repetition point. Upon solving the simultaneous equations, with the following equations (18) to (20), the solutions of dy, dx, dz are derived in order of (18), (19), (20). In the following equations, g(x), g(y) and g(z) respectively correspond to −(b−Axₖ), −(A^{T}yₖ−Qxₖ+zₖ−c) −{Xₖzₖ −(âxₖ^{T}zₖ/n)}.

A(Q+X⁻¹Z)⁻¹A^{T}dy=−g(x)−A(Q+X⁻¹Z)⁻¹(g(y)−X⁻¹g(z)) (18)

(Q+X⁻¹Z)⁻¹dx=−g(y)+X⁻¹g(z)−A^{T}dy (19)

dz=X⁻¹g(z)−X⁻¹Zdx (20)

In the equations (18), (19) and (20), X and Z are respectively diagonal matrixes having x and z in diagonal element.

For solving the equation (18), process is performed by blocking the matrix. However, since the contents of the process is complicate, discussion will be given with reference to FIGS. 15 to 18. In the drawings, there is illustrated a case where constraint of business category group is considered. Concerning the casewhere the constraint of the business category group is not considered, partial matrix relating to Aₛ is eliminated from object for calculation. Other portions of process are identical.

Upon solving the equation (18), at first, it becomes necessary to derive inverse matrix of Q+X⁻¹Z. Number of dimensions of the matrix Q+X⁻¹Z becomes (N+K) wherein the individual name and number of common factor are respectively N and K. Accordingly, in the example from FIG. 2 to FIG. 5, since N=1432 and K=13, number of dimension of the matrix Q+X⁻¹Z is 1445.

As shown in FIG. 15, the structure containing the elements is the same as the matrix Q, and the elements other than zero are present in the left upper diagonal portion and right lower portion. Accordingly, upon deriving inverse matrix of Q+X⁻¹Z, in consideration of such matrix structure, as a preliminary process for solving the problem of optimal portfolio, the coefficient matrix Q appearing in the objective function is divided into a first partial matrix relating to the individual floating factor and a second partial matrix relating to common floating element. It should be noted that the first partial matrix is a diagonal matrix having elements in a portion of diagonal component corresponding to number of financial product which can be selected, the second partial matrix is a matrix taking dimension of the product of the common floating factor and the common floating factor. Associating with this. the diagonal matrix of X⁻¹Z is also divided into two portions.

Concerning the left upper portion of FIG. 15, simply inversed value may be calculated. Only for the right lower portion, inverse matrix calculation routine, such as triangular factorization method or the like, may be applied. Accordingly, number of dimension of the matrix, to which the inverse matrix calculation routine is applied, becomes K (K=13 in the example of FIGS. 2 to 5). In general, the calculation period the inverse matrix is proportional to cubic of number of dimension of the matrix. In case of K=13, the calculation period is appreciated as about one millionth of (14/1446)*(14/1446)*(14/1446). On the other hand, even by elimination of necessity of making judgment whether the elements are zero, the process period can be reduced

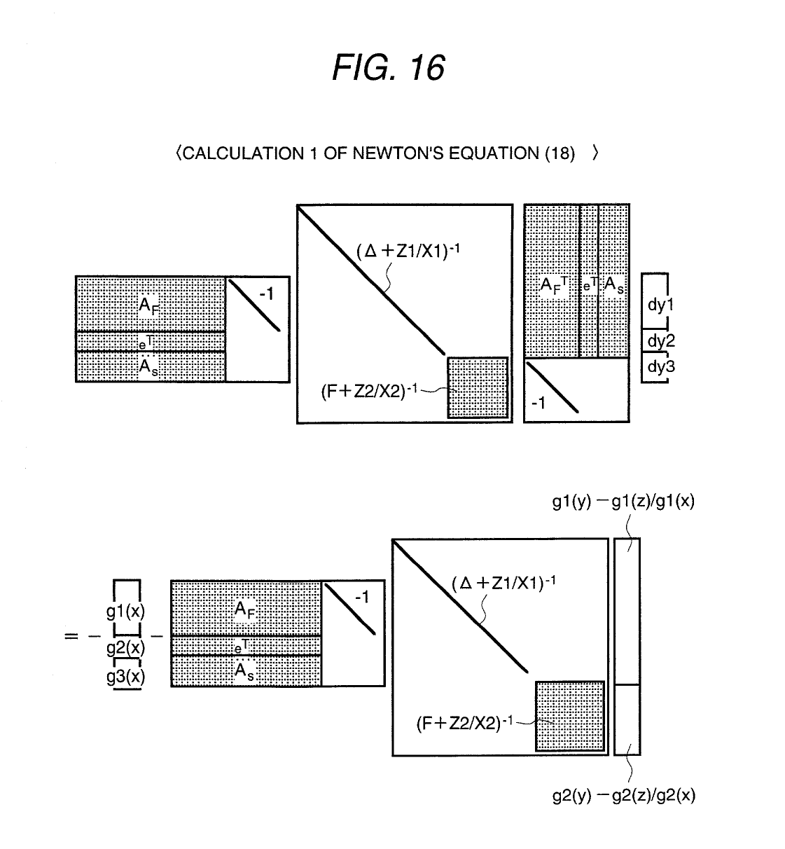

After deriving (Q+X⁻¹Z)⁻¹ as set forth above, a product of the matrix Aa nd(Q+X⁻¹Z)⁻¹ is derived. The element structure of respective matrix in the Newton's equation (18) is as shown in FIG. 16. Even in FIG. 16, similarly to FIGS. 13 and 14, calculation is implemented in consideration that most of lower half of the coefficient matrix A^{T} is zero and the elements other than zero are contained in only left upper diagonal portion and right lower portion.

Namely, when the constraint of the business category group is not considered, as a preliminary process for solving the problem of the optimal portfolio, the matrix A consisted of constraint parameters is divided into a partial matrix relating to financial products and common floating factor, a partial matrix relating to common floating factor and a partial matrix relating to the financial product and the purchasing amount thereof. On the other hand, when the constraint of the business category group is considered, as a preliminary process for solving the problem of the optimal portfolio, the matrix A consisted of constraint parameters is divided into a partial matrix relating to financial products and common floating factor, a partial matrix relating to common floating factor, a partial matrix relating to the financial product and the purchasing amount thereof, and a partial matrix relating to the purchasing amount of each group when the financial products are grouped into a plurality of groups.

On the other hand, when the constraint of the business category group is considered, the structure of the matrix A is characterized in that the partial matrix relating to the financial products and the common floating factor is the matrix taking the product of the financial products and the common floating factor as number of dimensions, and the partial matrix relating to the common floating matrix is the diagonal matrix having the elements in the portion of the diagonal product corresponding to number of the common floating factors, and the partial matrix relating to the constraint of the purchasing amount of the financial products is the partial matrix having the element in the portion of the diagonal component corresponding to number of the financial products. On the other hand, when the constraint of the business category group is considered, relative to the case not considering, the partial matrix relating to the constraint of the purchasing amount of the group, in which the financial product belongs, is the matrix taking the product of the number of groups and the financial products as number of dimensions.

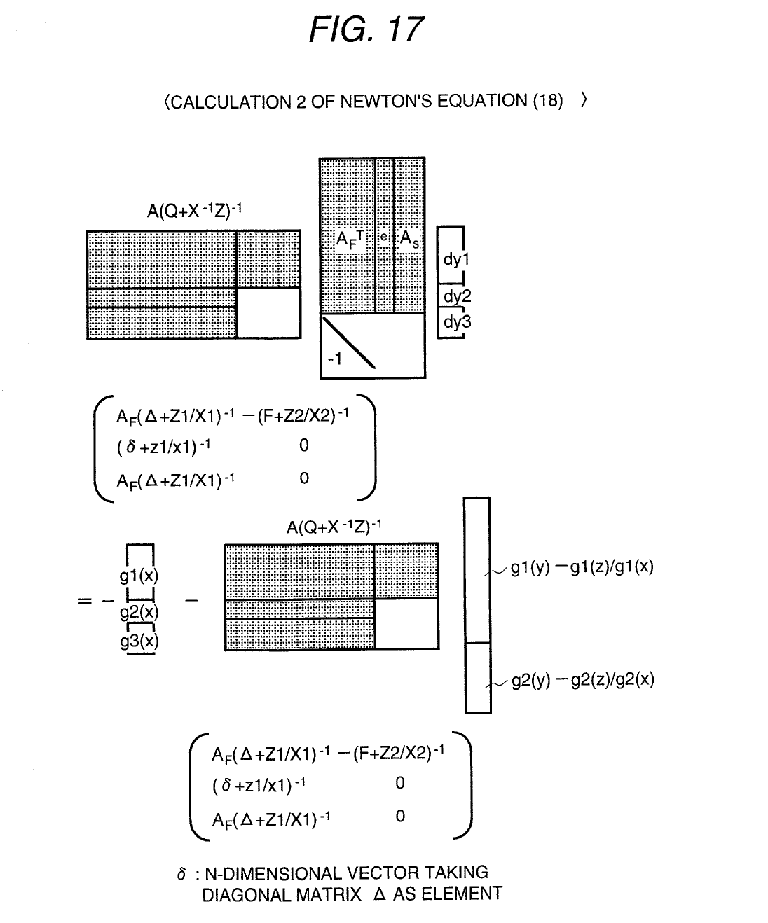

The matrix (Q+X⁻¹Z) is subject to the preliminary process to be divided in the similar method as the coefficient matrix Q appearing in the objective function. On the other hand, since A×(Q+X⁻¹Z)⁻¹ appears in left side and right side FIG. 16. Therefore, the structure of the element of the matrix after deriving the product of the matrix becomes as shown in FIG. 17. FIG. 17 shows that the right lower portion is zero in the matrix Ax(Q+X⁻¹Z)⁻.

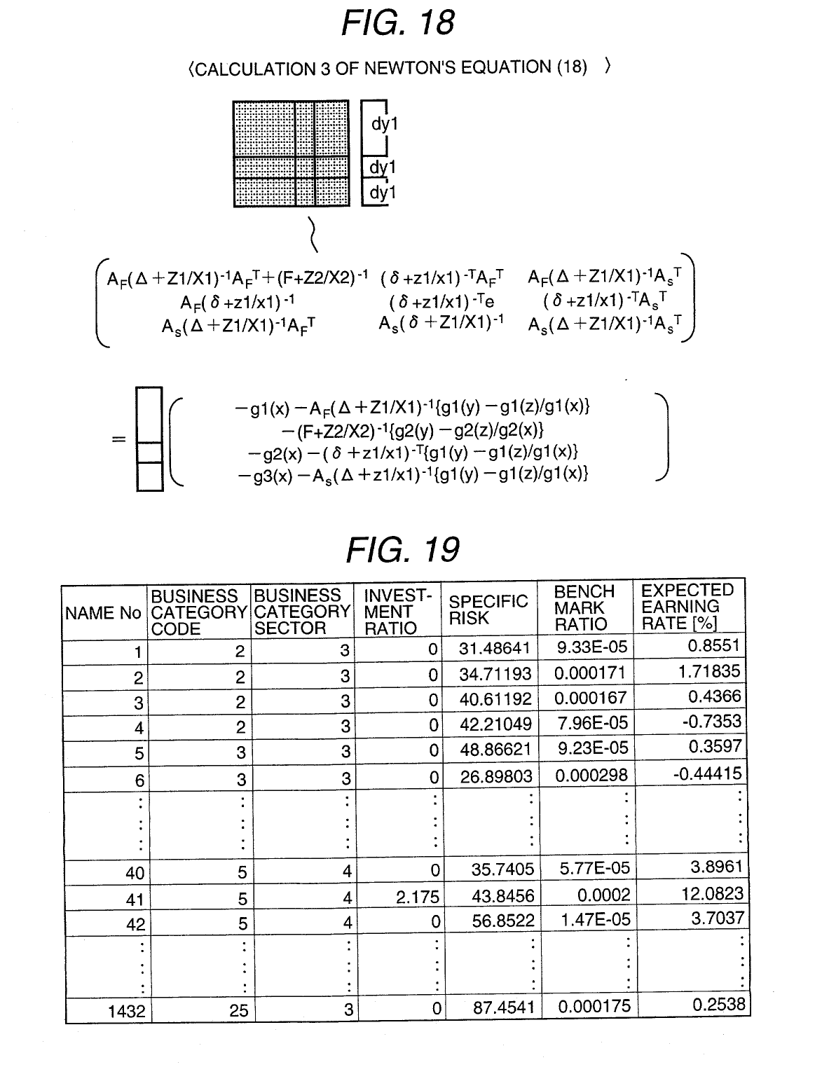

Furthermore, after calculating Ax″Q+X⁻¹Z)⁻¹×A^{T}, the element structure of the matrix becomes as shown in FIG. 18. In FIG. 18, while all elements are non-zero elements, the size of the matrix is 13×13 dimensions and the period required for calculation is small. As shown in FIG. 18, after executing the arithmetic process of the matrix and the vector, the simultaneous equation is solved by Gaussian elimination. The solution thus obtained is taken as dy. Thereafter, substituting the expression (19) with dy, dx is derived through the similar matrix process. Also, by substituting the expression (20) with dx, dz is derived.

Through a sequence of matrix process in FIGS. 16 to 18, unnecessary load, such as calculation of zero element or judgment whether zero element (only non-zero element is calculated), can be eliminated. On the other hand, as a result, it is not required to directly handle (N+K)th quadratic matrix to make the size of the matrix upon arithmetic operation of the inverse matrix and application by Gaussian elimination, can be small.

<Step 1208: Calculation of Step Width>

At step 1208, the step width indicative of degree of updating at the current repetition point is calculated. Calculation method of the step width is as follow.

á=min(−xₖ/dx), taking all elements of dx where dx<0 is established (21)

á_{d}=min(−zₖ/dz), taking all elements of dz where dz<0 is established (22)

As shown in the foregoing expressions (21) and (22), upon execution of interior point method, the point string is updated so that the values of parameters xₖ and zₖ to be object of non-negative constraint become positive.

<step 1209: Updating of Repetition Point>

At step 1209, the current repetition point is updated on the basis of the retrieving direction (dx, dy, dz) and the step width (áₚ, á_{d}) respectively calculated at steps 1207 and 1208. Updating is performed with the following equations.

xₖ₊₁=xₖ+áₚdx (23)

yₖ₊₁=yₖ+á_{d}dy (24)

zₖ₊₁=zₖ+á_{d}dz (25)

<Step 1210: Setting of Current Repetition Point at Optimal Solution>

At step 1210, since it is known that the repetition point after updating satisfies the optimal conditions (11), (12) and (13), this repetition point is set at the optimal solution. These information relating to the repetition point is displayed in the optimal portfolio display means.

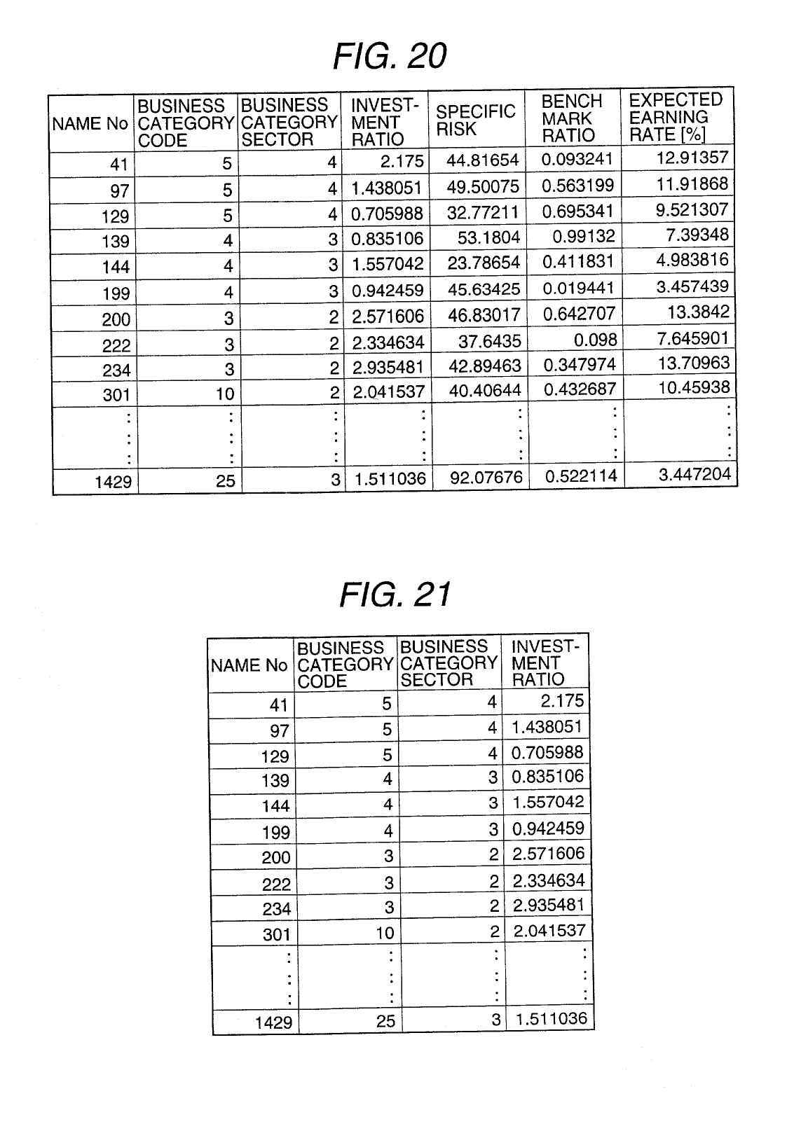

Discuss ion will be given for the embodiment for outputting the information relating to the optimal resource derived in the optimal portfolio deriving means 105 in the optimal portfolio output means 106. FIGS. 19 and 20 show examples of output in the case where 1432 names are taken as objects.

FIG. 19 shows display of investment ratio of each name for all of the individual name including names, to which the investment ratio is zero. Here, data relating to the business category code, business category sector, investment ratio, specific risk, bench mark ratio, expected earning rate are displayed. FIG. 20 shows display for the name of the investment object, and the items to display are the same as those of FIG. 19.

It should be noted that, in FIGS. 19 and 20, parameters relating to the expected earning rate and variation rate of the earning rate of each individual name are output in addition to the investment ratio of each name. It is also possible to set the type of output limiting the outputting object to the business category code and the business category sector as shown in FIG. 21. On the other hand, it is further possible to set for displaying parameter relating to the common factor of individual name to see association between the common factor and the investment ratio.

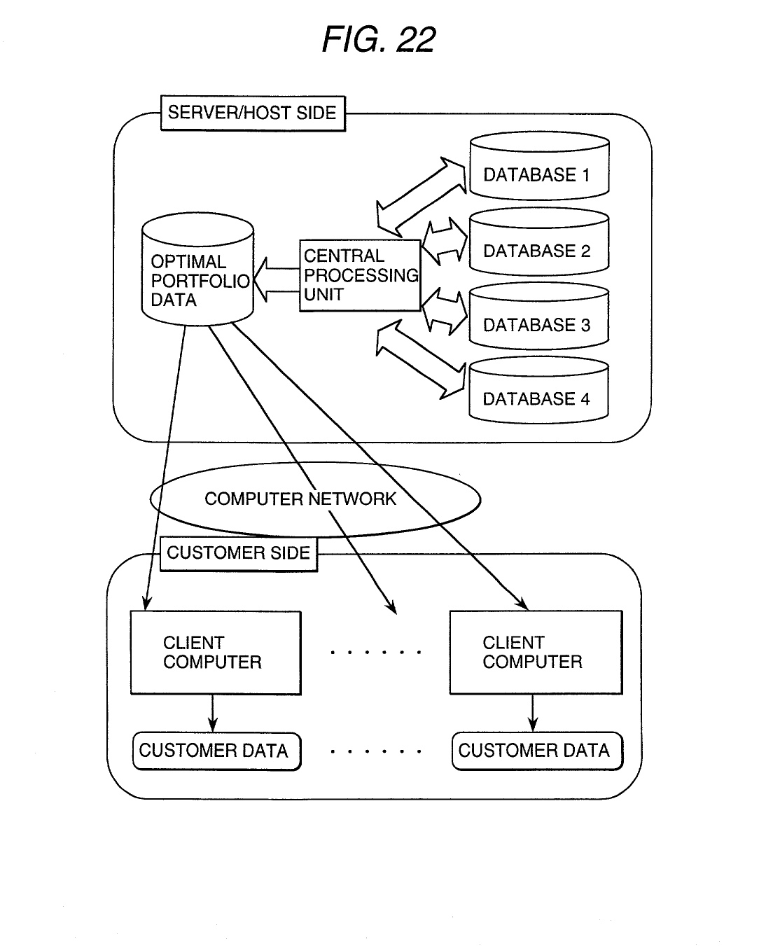

FIG. 22 shows one example of a system construction of the optimal portfolio determining system according to the present invention. The shown system for calculating the optimal portfolio and presenting to each customer is constructed with a personal computer. Upon derivation of the optimal portfolio, database storing information, such as information relating to individual names and parameters influencing for earning of the individual names. An application software performing simulation on the basis of the database and displaying the result of simulation to each customer, is required.

In FIG. 22, a plurality of computers owned by the customers are connected to a computer network. In a server/host computer, the application for establishing the database is installed, and four database connected to the server are stored. Here, the four database respectively store constraint parameters forming constraint conditions for optimizing the objective function and consisted of the expected value of the earning rate of each individual financial product, common floating factor as factor influencing for earning of overall financial products, and risk influencing for the earning rate and earning of the overall financial products.

In a central processing unit, an application software for performing calculation of the optimal portfolio and a program for displaying a result of simulation to the user are installed for executing simulation for calculating the optimal portfolio based on data input from the four database. Data relating to the optimal portfolio calculated by the central processing unit is transferred to a client computer on the side of the customers via the computer network.

The client computer on the side of the customer receives the information relating to the optimal portfolio calculated by the computer on the side of the server to display the optimal portfolio. Also, in the client computer, an application program for displaying the optimal portfolio and application program for inputting data relating to optimization indicia for the customer have to be installed.

Thus, by establishing the system construction of the optimal portfolio determination system according to the present invention, it becomes possible to determine optimal portfolio.

With the portfolio determining method and system, the fund manager or the like investing to the stock and so forth being deposited capital fund by the customers may efficiently determine the financial product, such as stock of the individual name as purchasing object and purchasing amount for optimizing utility of the investor consisted of the risk and return. It should be noted that, in determination of the purchasing object, the parameter indicating of the earning ability or the like of the individual investing object has to be predicted by executing statistical process, such as regression analysis are predicted for a plurality of times and the mathematical programming problem formulated by solving quadratic programming problem has to be solved for many times. The present invention is significantly effective in shortening the period for calculating the optimal portfolio.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An optimal portfolio determining method for determining purchasing amounts of respective financial products among a plurality of financial products so as to optimize an objective function consisted of earning rate of all of a plurality of financial products and risk influencing for earning, comprising:
input step of inputting constraint parameters forming constraint condition for optimizing objective function consisted of an expected value of the earning rate of each individual financial product, individual floating factor as unique factor of each individual financial product influencing for earning, common floating factor as factor influencing for earning of overall financial products, and risk influencing for earning rate and earning of overall financial product; and
solving step of determining financial product to purchase and purchasing amount for maximizing said objective function on the basis of input data.

2. An optimal portfolio determining method as set forth in claim 1, which comprises preliminary process step of processing of dividing a coefficient matrix appearing in said objective function into a partial matrix relating to individual floating factor of each individual financial product, and a partial matrix relating to the common floating factor, upon determining the financial product to purchase and purchasing amount.

3. An optimal portfolio determining method as set forth in claim 2, wherein said partial matrix relating to said individual floating factor is a diagonal matrix having elements in a portion of diagonal component corresponding to number of financial products to be selected.

4. An optimal portfolio determining method as set forth in claim 2, wherein said partial matrix relating to said common floating factor is a matrix taking square of said common floating factor as dimension.

5. An optimal portfolio determining method as set forth in claim 1, which comprises preliminary process step of processing of dividing a matrix consisted of said constraint parameters into a partial matrix relating to said financial products and said common floating factor, a partial matrix relating to said common floating factor, and a partial matrix relating to said financial product and purchasing amount thereof.

6. An optimal portfolio determining method as set forth in claim 5, wherein said partial matrix relating to said financial product and said common floating factor is a matrix taking a product of said financial product and said common floating factor as dimension.

7. An optimal portfolio determining method as set forth in claim 5, wherein said partial matrix relating to said common floating factor is a diagonal matrix having element in a portion of diagonal component corresponding to number of said common floating factor.

8. An optimal portfolio determining method as set forth in claim 5, wherein said partial matrix relating to constraint for purchasing amount of said financial product is a diagonal matrix having element in a portion of diagonal component corresponding to number of said common floating factor.

9. An optimal portfolio determining method as set forth in claim 1, which comprises preliminary process step of processing of dividing a matrix consisted of said constraint parameters into a partial matrix relating to said financial products and said common floating factor, a partial matrix relating to said common floating factor, a partial matrix relating to said financial pro duct and purchasing amount thereof, and a partial matrix relating to purchasing amount of each group in the case where said financial products are grouped into a plurality of groups.

10. An optimal portfolio determining method as set forth in claim 9, wherein said partial matrix relating to said financial product and said common floating factor is a matrix taking a product of said financial product and said common floating factor as dimension.

11. An optimal portfolio determining method as set forth in claim 9, wherein said partial matrix relating to said common floating factor is a diagonal matrix having element in a portion of diagonal component corresponding to number of said common floating factor.

12. An optimal portfolio determining method as set forth in claim 9, wherein said partial matrix relating to constraint for purchasing amount of said financial product is a diagonal matrix having element in a portion of diagonal component corresponding to number of said common floating factor.

13. An optimal portfolio determining method as set forth in claim 9, wherein said partial matrix relating to constraint for purchasing amount of the group, in which said financial products belong, is a matrix taking a product of number of said groups and said financial products.

14. An optimal portfolio determining method as set forth in any one of claims 1 to 13, which further comprises display step outputting the risk indicative of variation of earning and earning rate consisting said objective function.

15. An optimal portfolio determining system having a computer unit for determining purchasing amounts of respective financial products among a plurality of financial products so as to optimize an objective function consisted of earning rate of all of a plurality of financial products and risk influencing for earning, said computer unit comprising:
storage device storing an expected value of the earning rate of each individual financial product;
storage device storing individual floating factor as unique factor of each individual financial product influencing for earning,
storage device storing common floating factor as factor influencing for earning of overall financial products, and
storage device storing constraint parameters forming constraint condition for optimizing objective function consisted of risk influencing for earning rate and earning of overall financial product;
optimal portfolio solving device determining financial product to purchase and purchasing amount for maximizing said objective function on the basis of data stored in said storage device; and
display device outputting determined optimal portfolio.

16. An optimal portfolio determining system as set forth in claim 15, wherein said computer unit comprises a server computer including respective storage devices and said optimal portfolio deriving device, and a plurality of client computers receiving information relating to the optimal portfolio calculated by said server computer for displaying, and said sever computer and said client computers are connected through a network.

17. An optimal portfolio determining program readable by a computer and including input step and solving step defined in claim 1.

18. A storage medium storing a program readable by a computer which stores a program executing said input step and solving step defined in claim 1 on the computer.
